(19) United States
(12) Patent Application Publication
(10) Pub. No.: US 2015/0120343 A1
(43) Pub. Date: Apr. 30, 2015

(54) METHOD AND APPARATUS FOR SOCIALLY CONTINGENT EVENT ADMISSION PURCHASE

(71) Applicant: TicketLeap, Inc., Philadelphia, PA (US)

(72) Inventors: Beah Alexandra BURGER-LENEHAN, Lansdowne, PA (US); Timothy James RAYBOULD, Ambler, PA (US)

(73) Assignee: TICKETLEAP, INC., Philadelphia, PA (US)

(21) Appl. No.: 14/064,439

(22) Filed: Oct. 28, 2013

(51) Int. Cl. G06Q 10/02; G06Q 30/06

(52) U.S. Cl. CPC G06Q 10/02; G06Q 30/06
USPC 705/5

(57) ABSTRACT

A system and method are provided for socially contingent purchase of tickets. The method includes receiving a contingent purchase request from a first buyer, receiving information regarding the identity of a second buyer, providing a notification to the second buyer, and executing the purchase for the first buyer upon execution of a purchase by the second buyer.

### BACKGROUND OF THE INVENTION

The present invention relates generally to systems and methods for socially contingent purchase of admission to events.

A common problem confronting ticket buyers is the coordination of ticket purchases amongst a group of people wishing to attend an event together. For many people, the decision as to whether to attend an event is contingent upon the decision of one or more other parties to also attend. Substantial communication and coordination is needed to determine who will be attending and when tickets may be purchased. Additionally, any one person may be reluctant to make the ticket purchase for the entire group due to the cost and the fear of being left with an unused ticket if a member of the group decides not to attend.

While each party could attempt to purchase his or her own ticket, the event may sell out before all members of the group have executed their purchases. Furthermore, in the case of an event with assigned seating, the members of the group would very likely not be able to sit together due to other purchases executed between their purchases.

Each of these factors may prevent buyers from executing ticket purchases. This may cause buyers to miss events they would have preferred to attend and, in turn, cause a loss of revenue for event producers. A system and associated methods are needed that facilitate purchase of tickets by members of a group when individual decisions regarding ticket purchase are made at different times and that remove the burden of coordination from ticket purchasers.

### BRIEF DESCRIPTION OF THE DRAWINGS

The foregoing summary, as well as the following detailed description of preferred embodiments of the invention, will be better understood when read in conjunction with the appended drawings.

For the purpose of illustrating the invention, there are shown in the drawings embodiments that are presently preferred. It should be understood, however, that the invention is not limited to the precise arrangements and instrumentalities shown.

FIG. 1 is an exemplary diagram of an ticket system in accordance with a preferred embodiment of the present invention;

FIG. 2A is an exemplary user interface screen in accordance with a preferred embodiment of the present invention;

FIG. 2B is an exemplary user interface screen in accordance with a preferred embodiment of the present invention;

FIG. 3 is an exemplary user interface screen in accordance with a preferred embodiment of the present invention;

FIG. 4A is an exemplary user interface screen in accordance with a preferred embodiment of the present invention;

FIG. 4B is an exemplary user interface for verifying a self-portrait for use in an electronic ticket in accordance with a preferred embodiment of the present invention;

FIG. 5A is an exemplary display of an electronic ticket using a captured self-portrait in accordance with a preferred embodiment of the present invention;

FIG. 5B is an exemplary display of an electronic ticket comprising a time display in accordance with a preferred embodiment of the present invention;

FIG. 6 is a sequence diagram of the process of self-portrait check-in for an event in accordance with a preferred embodiment of the present invention;

FIG. 7A is an exemplary user interface screen for a ticket transfer process in accordance with a preferred embodiment of the present invention;

FIG. 7B is an exemplary user interface screen for confirmation of a ticket transfer process in accordance with a preferred embodiment of the present invention;

FIG. 8 is a sequence diagram of the ticket transfer process in a preferred embodiment of the ticketing system;

FIG. 9 is a diagram of an exemplary hardware implementation of a server 110 of the ticketing system;

FIG. 10 is a sequence diagram of an example of a socially contingent ticket purchase scenario;

FIG. 11A is an example of a ticket selection screen for a particular event;

FIG. 11B is an example of an invitation user interface for a socially contingent ticket purchase; and

FIG. 11C is an example of a user interface screen for payment.

### DETAILED DESCRIPTION OF THE INVENTION

Certain terminology is used in the following description for convenience only and is not limiting. The words “lower,” “bottom,” “top” and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

A system and method are provided for socially contingent purchase of tickets. The method includes receiving a contingent purchase request from a first buyer, receiving information regarding the identity of a second buyer, providing a notification to the second buyer, and executing the purchase for the first buyer upon execution of a purchase by the second buyer. Referring to the drawings in detail, wherein like reference numerals indicate like elements throughout, a preferred ticketing system is described.

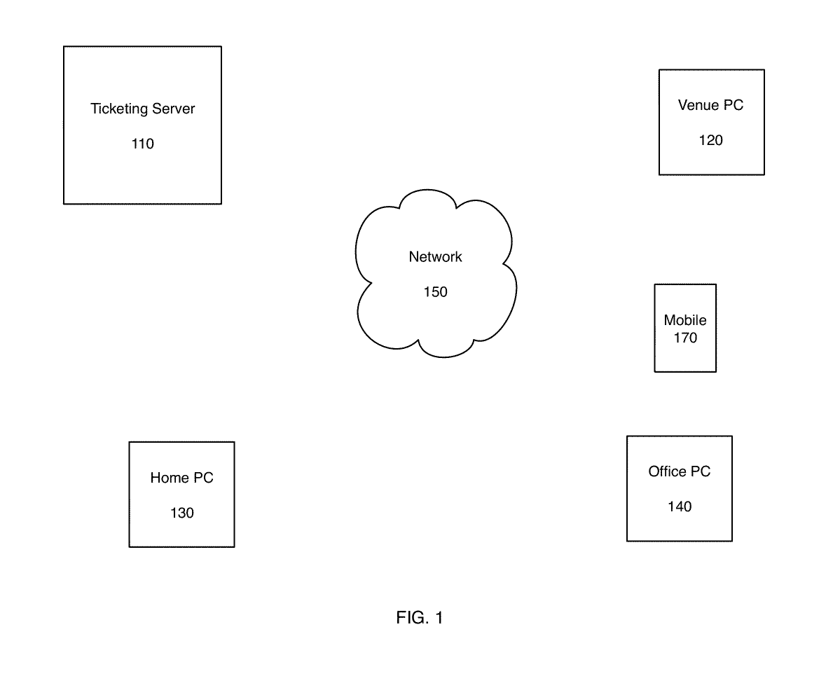

FIG. 1 is an illustration of an environment in which a ticketing server may operate. A ticketing server 110 provides ticketing functionality. A producer of an event at a venue computer 120, or other computing device, may access ticketing server 110 to create the event in the system. Parameters such as the number of tickets to be sold, pricing tiers, seating charts, and date and time may be provided to ticketing system 110. Once the event is created, customers at home computers 130, office computers 140, or mobile devices 170 may access the ticketing server to search for events and purchase tickets.

In a preferred embodiment, each mobile device 170 runs an application associated with the ticketing system, which may allow the user to search, purchase, or transfer tickets, as well as, in certain embodiments, generate a self-portrait electronic ticket. While the following figures describe various aspects of the user interface of a mobile device application, it is to be understood that similar interfaces may also be implemented in other forms, such as web pages generated by the ticketing system server, which may be displayed on desktop or mobile devices. It is to be further understood that while the example of the following discussion relates to event check-in, the scope of the invention extends to redemption of other types of tickets, claim checks, passes, vouchers, or coupons. For instance, a self-portrait electronic ticket may be used to facilitate in-store pickup of an online purchase or boarding of a train or airplane.

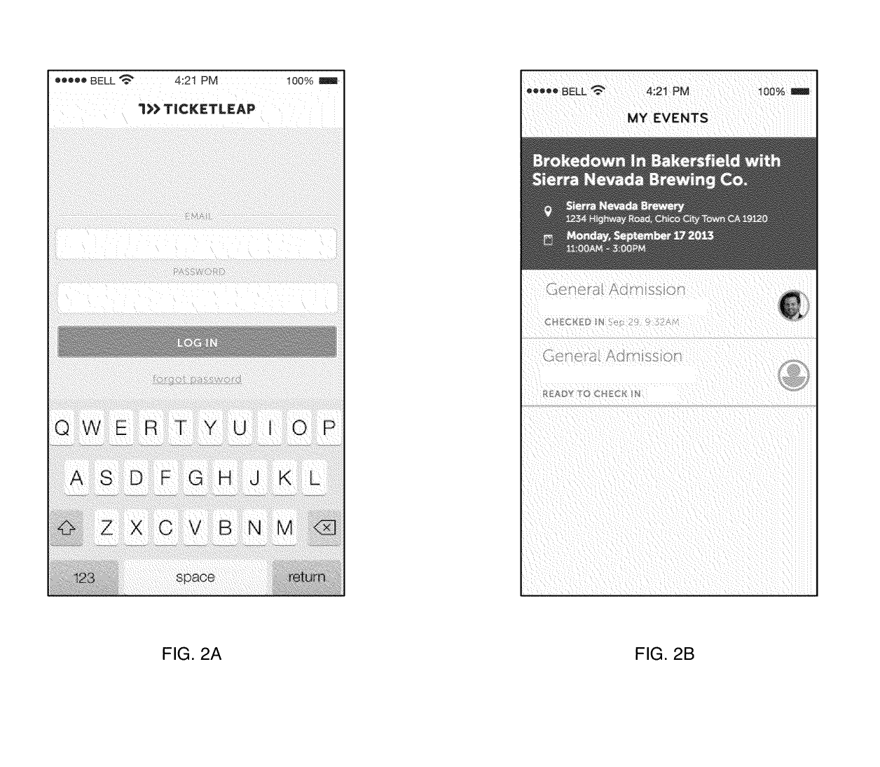

FIG. 2A is an exemplary user interface that may be presented to a user either upon launch of the mobile application, upon an attempt to access a function requiring authentication within the mobile app, or upon explicit selection of a login function. In some cases, after a ticket is purchased via other means, such as via a web site on a home computer, the user may be emailed information to facilitate download of a mobile application associated with the ticketing system. The user may then download and install the application and may then be presented with a login interface, such as the one shown in FIG. 2A. In some cases, the email to the user may contain a temporary password to allow check-in with the mobile application without creation of an account or with streamlined or automatic creation of an account. Check-in is used to refer generally to a transition of the ticket status from a pre-redemption to a redeemed or partially redeemed state. As described below, check-in may occur when the ticket purchaser is at the venue or at another location.

FIG. 2B is an exemplary user interface for displaying a list of events for which an authenticated user has purchased tickets. In a preferred embodiment, the user interface displays the name, location, and time of the event, as well as a check-in status for each attendee associated with a particular ticket purchase or known group of attendees.

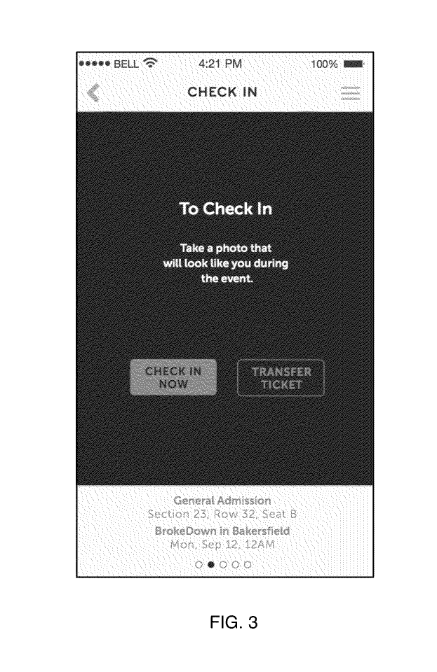

FIG. 3 is an exemplary check-in user interface to be presented to the user in response to selection of a ticket from the user interface of FIG. 2B. In a preferred embodiment, check-in for a particular event will not be enabled until a predetermined time before that event, such as 24 hours. This will help to ensure that only those who are sure they will be attending use the check-in function. The check-in window may preferably be closed at the time the event ends or is scheduled to end. In some embodiments, the check-in interface may provide an indication that the event has started, if applicable.

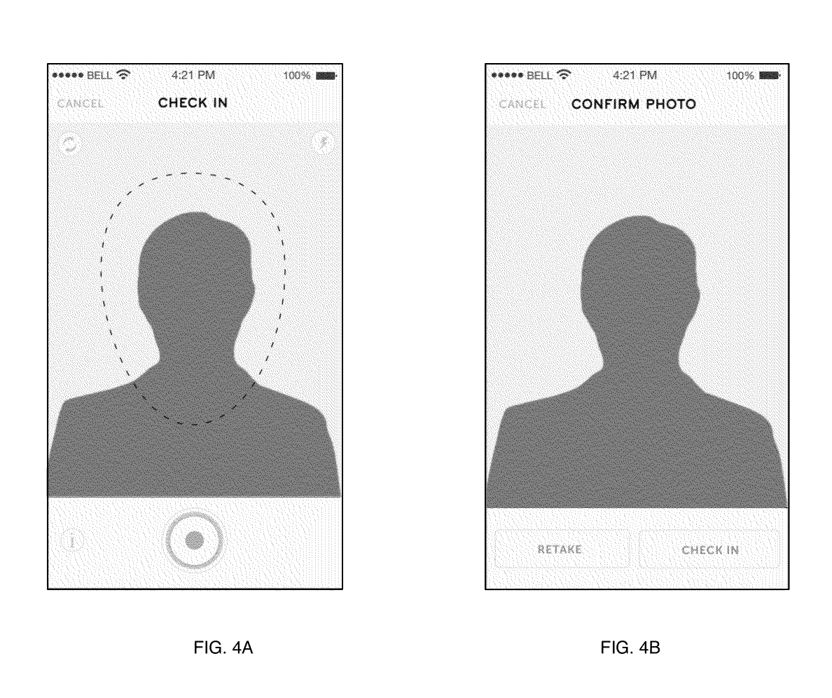

FIG. 4A is an exemplary user interface for capturing a self-portrait for use in an electronic ticket. The user interface may preferably present an outline to guide the user in positioning the camera to take an appropriately oriented and sized headshot. The interface may further provide textual or audio cues to assist the user in taking an appropriate portrait. An introductory screen may be displayed before the camera is activated to explain the process or provide some warning to the user that the camera will be activated.

FIG. 4B is an exemplary user interface for verifying a self-portrait for use in an electronic ticket. The user interface may present the captured photo to the user and provide user interface options to retake the photo or accept the photo. In some embodiments, the ability to retake photos may be restricted around the time of events to prevent use of the same electronic ticket by multiple parties.

Once the self-portrait electronic ticket is created, it may be used to gain entry to an event. Instead of being required to scan a paper ticket, a person manning a gate may simply look at the screen of the mobile device, confirm the expected ticket features are present, confirm the patron matches the displayed portrait, and allow the patron to enter.

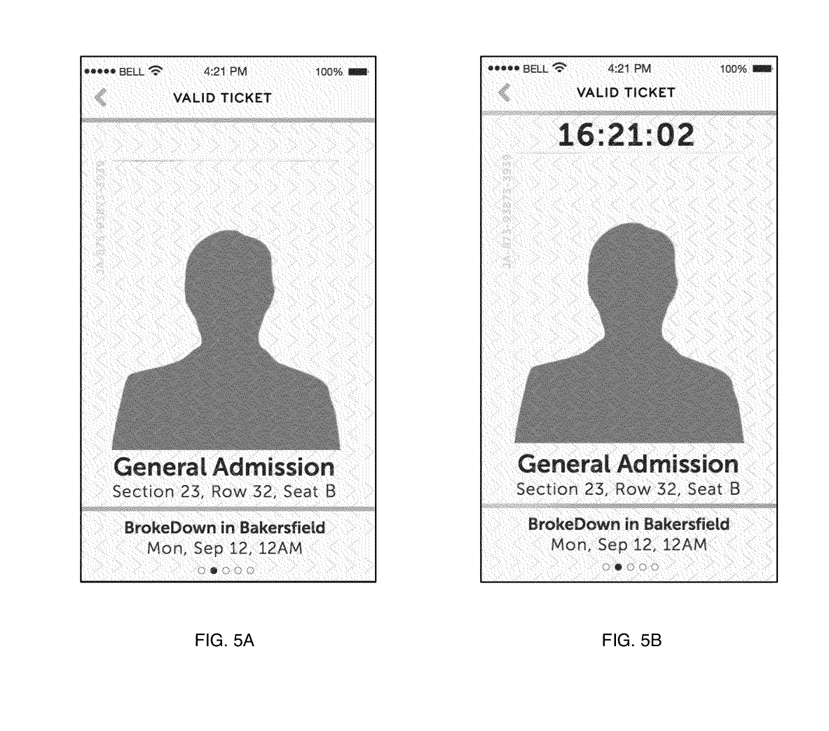

FIG. 5A is an exemplary display of an electronic ticket using a captured self-portrait. In addition to an image derived from the captured self-portrait, the electronic ticket display may also comprise an indication of the event, an indication of the type of ticket, and indication of seat location, if applicable, and an indication of the date of the event. In a preferred embodiment, sufficient information is stored within the application such that the ticket will be displayed even in the absence of a network connection.

The image may be modified or additional graphical elements may be presented, for example, to prevent counterfeiting. Modifications to the image or ticket may be event specific. In some embodiments, the graphical element or other elements of the electronic ticket may be animated. The use of animation may prevent counterfeiting of the electronic ticket using a still image on the mobile device. In a preferred embodiment, an animated watermark is rendered over the ticket display. Certain aspects of the ticket may be left outside of the control of the event creator, for instance, as a security measure to prevent the creation of parallel events for the purpose of creating tickets identical to those of the legitimate event.

The particular design used for tickets for an event may be fully or partially under the control of the event producer. Various options may be provided during the setup process for the event to allow such selections.

In some embodiments, the animation or other graphical modifications may not be displayed until a short time before the event to further hinder counterfeiting. In a preferred embodiment, a “pre-ticket” lacking certain elements is displayed to the user up until a certain time before the event. After that time, a live ticket with the additional elements is display. In a preferred embodiment, one of the elements added in the live ticket is a live time display.

FIG. 5B is an exemplary display of an electronic ticket comprising a time display. A ticket with time display may be used, for example, to prevent the use of a looping video as a counterfeit ticket.

In some embodiments, upon detection of attempts at creating counterfeit electronic tickets for an event, the event producer may initiate changes in the unique event features. Ticket server 110 may then send messages to all known mobile devices 170 running the ticketing app and known to be associated with users who purchased tickets to the event. Information sent to the mobile device app may then be used to cause the display of a modified ticket comprising new features.

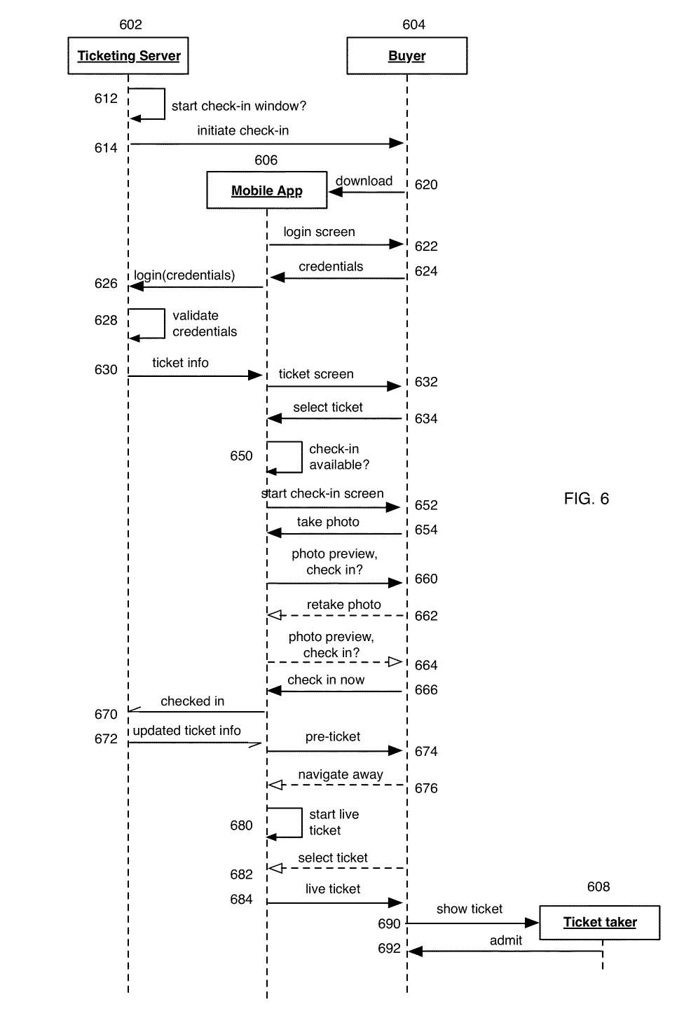

FIG. 6 is a sequence diagram of the process of self-portrait check-in for an event. It is to be understood that the sequence diagram and accompanying description describe one possible flow of events for illustrative purposes and are not intended to be limiting. The scenario illustrated in this sequence diagram assumes the ticket buyer already has an account with the ticketing server, possibly established during the purchase of the ticket, but has not yet downloaded the mobile application.

At 612, ticketing server 602 starts the check-in window for an event. At 614, ticketing server 602 sends an email or other notification to buyer 604. It is to be understood that the notification may be presented to buyer 604 by an intermediate device such as a mobile device or computer. At 620, if buyer 604 is using the ticketing process for the first time, buyer 604 initiates the download of mobile application 606.

Upon launch of the mobile application 606, buyer 604 is presented with a login screen at 622. The login screen may preferably resemble the user interface screen of FIG. 2A. At 624, buyer 604 provides login credentials to mobile application 606. Mobile application 606 then passes the login credentials, or information derived from the login credentials, to ticketing server 602.

At 628, ticketing server 602 validates the credentials. Upon validation, ticketing server 602 sends ticket information to mobile application 606 at 630. At 632, mobile application 606 presents a ticket screen to buyer 604. The ticket screen may preferably resemble the user interface shown in FIG. 2B. At 634, buyer 604 selects a ticket from the display.

At 650, mobile application 606 determines whether check-in is available for the event associated with the selected ticket. Mobile application 606 may contact ticketing server 602 to make this determination. Responsive to a determination that check-in is available, mobile application 606 presents a user interface for starting the check-in process to user 604 at 652. The user interface for starting the check-in may preferably resemble the user interface of FIG. 3.

At 654, buyer 604 indicates she is ready to take a photo for the self-portrait check-in. The photo interface may preferably resemble that shown in FIG. 4A. At 660, mobile application 606 presents buyer 604 with a preview of the self-portrait and an option to use it for check-in to the event. The displayed screen may preferably resemble the user interface shown in FIG. 4B. At 662, buyer 604 optionally requests that the photo be retaken. At 664, a new preview is shown to buyer 604.

At 666, buyer 604 selects a user interface element to check-in to the event. At 670, mobile application 606 informs ticketing server 602 that the user has initiated check-in. At 672, ticketing server sends updated ticket information to mobile app 606.

At 674, if the time until the event still exceeds a threshold, mobile application 606 presents a pre-ticket to buyer 604. The pre-ticket may resemble the ticket illustrated in FIG. 5A. At 680, when the time remaining until the event is below the threshold, mobile application 606 transitions the ticket to a live ticket.

At 682, buyer 604 selects the ticket for presentation. This selection may be made by launching the mobile application 606 and making a selection or through other mechanisms such as selecting a time- or location-triggered alert or notification on the mobile device. At 684, mobile application presents the live ticket to buyer 604. The live ticket may resemble the ticket illustrated in FIG. 5B.

At 690, buyer 604 presents the live ticket display to a ticket taker at the venue. The ticket taker compares the ticket to the known ticket attributes for the event and admits buyer 604 to the event at 692. Since the ticket comprises a photo of the buyer and is not a physical ticket that needs to be confiscated, altered, or otherwise “used up” upon entry, it may provide the advantage of being used for reentry.

In some cases, a ticket buyer may purchase tickets for herself and for others in the same or multiple transactions. In other cases, the buyer may be unable to attend the event associated with a ticket and wish to provide the ticket to another party. For these and other circumstances, a preferred embodiment of the ticketing system provides a ticket transfer process.

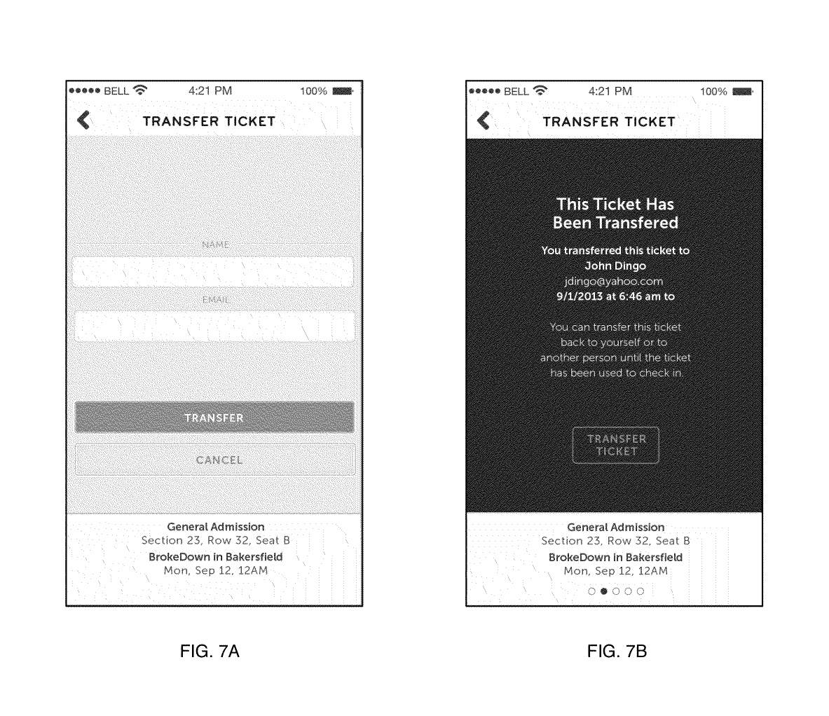

FIG. 7A is an exemplary user interface screen for a ticket transfer process. In a preferred embodiment, an authenticated user may select a transfer option on a user interface screen displaying unused tickets purchased by the user, such as the interface screen shown in FIG. 2B. The user may then be presented with an interface, such as that of FIG. 7A, where the name and email address, or other identifier or address, may be entered. In some embodiments, the user may have been asked for names of friends who may be attending the event during the checkout process. In those cases, those names may be made available in the transfer user interface as selections, removing the need for the user to enter the information.

FIG. 7B is an exemplary user interface screen for confirmation of a ticket transfer process. After selecting the transfer button in the interface of FIG. 7A, a transfer process is initiated, as will be described in further detail below. A confirmation screen may then be presented to the user to confirm that the requested transfer took place. The user interface may also provide an interface element to allow the user to request transfer of the ticket back to herself. In preferred embodiments, the buyer of the ticket will later be able to see the status of a ticket transfer, including, for instance, the identity of the transferee and whether that person has created an account with the ticketing system. Similarly, the recipient of the transferred ticket should be able to see the name or other identifying information related to the buyer.

In a preferred embodiment, a buyer may transfer one or more of her tickets to a user at any email address. The recipient is then considered the ticket holder, though the buyer may still be allowed to transfer the ticket to another address. This effectively provides dual ownership of the ticket. The new ticket holder may also be allowed to transfer the ticket to a third party, at which point the second holder will no longer be the ticket holder and will have no remaining rights to do anything with that ticket. Ownership would then be shared by the buyer and the new, third, ticket holder. In an alternative embodiment, the initial transferee may retain some ownership, along with one or both of the other parties.

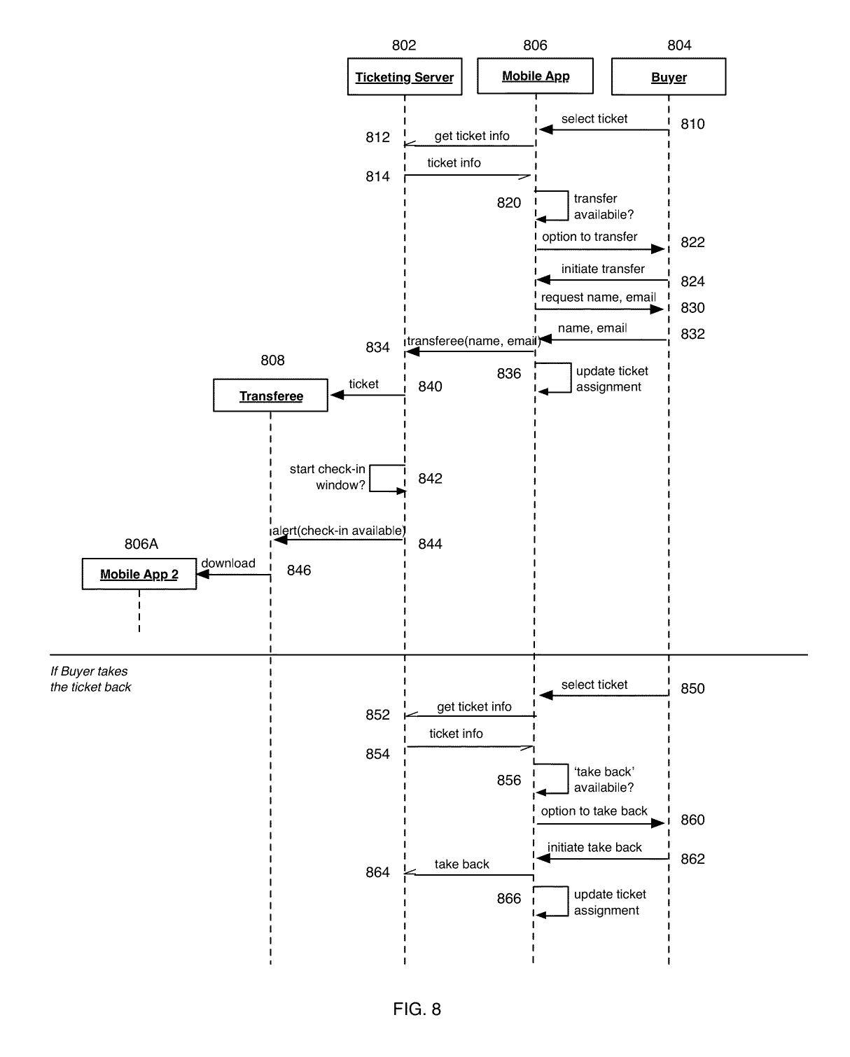

FIG. 8 is a sequence diagram of the ticket transfer process in a preferred embodiment of the ticketing system. At 810, buyer 804 selects a ticket from a display presented by mobile application 806. Mobile application 806 contacts ticketing server 802, requesting information regarding the selected ticket, at 812. At 814, ticketing server 802 returns information regarding the selected ticket to mobile application 806. At 820, mobile application 806 determines whether the ticket may be transferred. If so, at 822, mobile application presents a user interface comprising an option to transfer the ticket to buyer 804. The presented user interface may preferably resemble the user interface illustrated in FIG. 3.

At 824, buyer 804 selects the user interface option to initiate transfer. At 830, mobile application 806 presents the user with a user interface configured to collect information regarding the transferee. The user interface may preferably resemble the user interface shown in FIG. 7A, providing input fields for a name and email address. At 832, buyer 804 provides the requested transferee information to mobile application 806.

At 834, mobile application 806 conveys the information regarding the transferee to ticketing server 802. At 834, ticketing server 802 transmits information regarding the ticket being transferred to transferee 808. Ticketing server 802 may send an email to the address provided by buyer 804. If transferee is already in possession of the mobile ticketing application, indication of the transfer may be provided as an alert associated with that application.

At 842, ticketing server 802 initiates the check-in window for the event associated with the ticket being transferred. At 844, ticketing server 802 notifies transferee 808, again, by email, alert, notification, or other method, that the opportunity exists to check-in. If transferee 808 does not already have the mobile application 806A, he may download it at 846, preferably using a link or other information provided in the notice of ticket transfer or notice regarding check-in. Transferee 808 may then perform the check-in process as described above with respect to FIG. 6.

In some embodiments, the original buyer 804 is allowed the opportunity to undo a transfer of a ticket to transferee 808. This process is illustrated in optional steps 850 to 866.

At 850, buyer 804 selects the ticket that was transferred. At 852, mobile application 806 requests information regarding the ticket from ticketing server 802. At 854, ticketing server 854 provides information regarding the selected ticket back to mobile application 806. At 856, mobile application 806 makes a determination as to whether the selected ticket may be taken back from transferee 808. Responsive to a determination that the ticket can be taken back, mobile application 806 presents a user interface option to initiate the take back at 860. At 862, buyer 804 selects the option to take back the ticket. At 864, mobile application 806 informs ticketing server 802 that the user has initiated a take-back of the ticket. At 866, mobile application 806 then updates the ticket assignment to indicate the ticket is again in the possession of buyer 804.

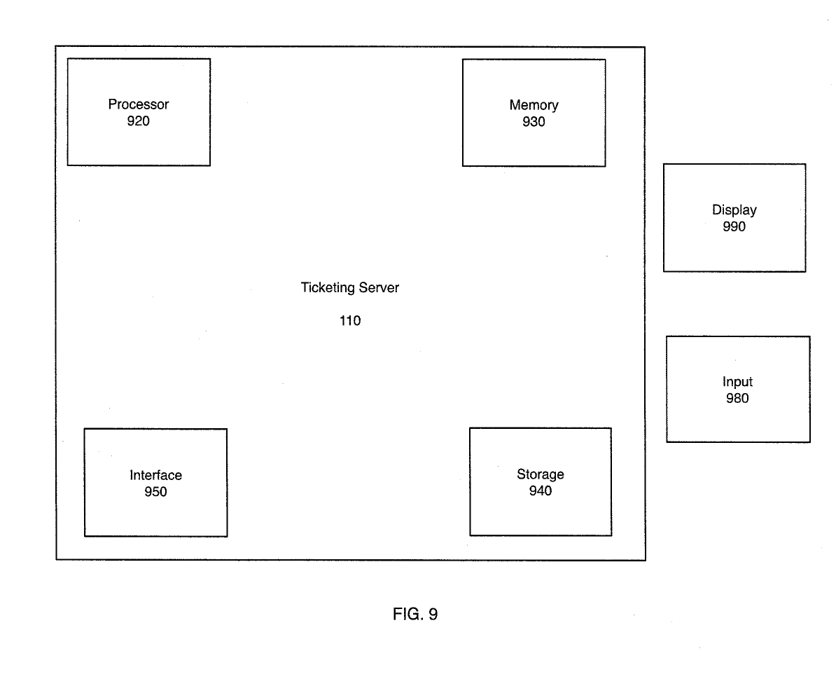

FIG. 9 is a diagram of an exemplary hardware implementation of a server 110 of the ticketing system. One or more processors 920 execute program code stored in memory 930 or storage 940. A network interface 950 allows communication with other devices such as mobile devices 170. A display may be provided to provide status to an operator. One or more input devices 980 may be provided to allow control of ticketing server 110.

Another problem confronting ticket buyers is the coordination of ticket purchases amongst a group of people wishing to attend an event together. For many people, the decision as to whether to attend an event is contingent on the decision of one or more other parties to also attend. Substantial communication and coordination is needed to determine who will be attending and when the precise number of attendees is known so the tickets may be purchased. Additionally, any one person may be reluctant to make the ticket purchase for the entire group due to the cost and the fear of being left with an unused ticket if a member of the group decides not to attend.

While each party may attempt to purchase his or her own ticket, the event may sell out before all members of the group have executed their purchases. Furthermore, in the case of an event with assigned seating, the members of the group would very likely not be able to sit together due to the time between their purchases.

Each of these factors may prevent buyers from executing ticket purchases. This may cause buyers to miss events they would have preferred to attend and, in turn, cause a loss of revenue for event producers. A system and associated methods are needed to facilitate purchase of tickets by members of a group when individual decisions regarding ticket purchase are made at different times.

In certain embodiments, the ticketing system may facilitate coordinated purchase of tickets without active coordination by the purchasers to address these and other problems. It is to be understood that the socially contingent purchase system and methods described below are complementary to, but do not depend upon, the self-portrait check-in functionality described above. A conventional check-in system may be used with the socially contingent purchase, the self-portrait check-in may be used with conventional purchase, or the two may be employed together.

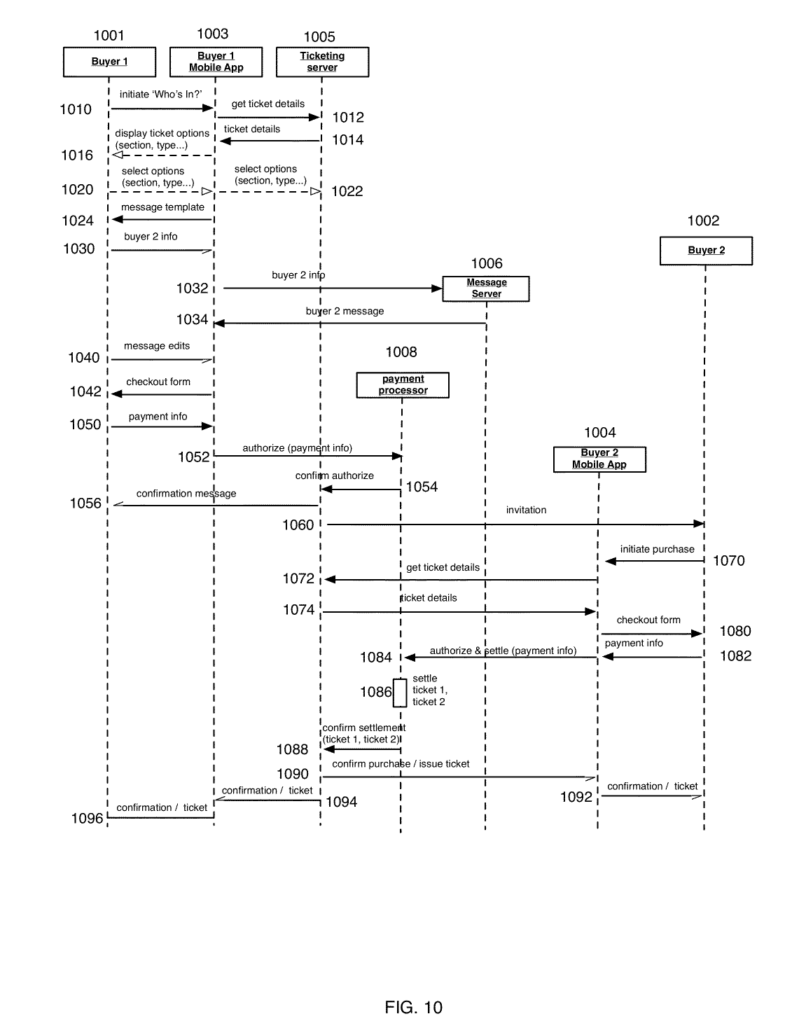

FIG. 10 is a sequence diagram of an example of a socially contingent ticket purchase scenario. It is to be understood that the sequence diagram and accompanying description describe one possible flow of events for illustrative purposes and are not intended to be limiting. The scenario assumes the user has already registered with the ticketing system, installed the mobile application, and been authenticated.

At 1010, a first buyer 1001 initiates a socially contingent purchase process using a mobile application 1003 associated with the ticketing system 1005. Mobile app 1003 may preferably be executed on a mobile device, such as a mobile phone. In other embodiments, the functions of mobile app 1003 may be provided a computer or device running a web browser presenting a web site. While the steps below will be described with respect to a mobile application, it is to be understood that other implementations may also perform the described methods.

At 1012 the mobile app contacts ticket server 1005 for information regarding available tickets. Intermediate steps may involve searching for a particular artist or performance. At 1014, ticketing server 1005 returns details regarding available tickets to mobile app 1003. At 1016, mobile app 1003 presents ticket information, such as information about available seats, pricing, ticket packages, etc. to buyer 1001. Presentation of the information may be performed using a variety of user interface techniques.

At 1020, information regarding ticket selection by user 1001 is provided to mobile app 1003. At 1022, information regarding the buyer's selections is sent to ticketing server 1005.

At 1024, mobile app 1003 presents a message template to buyer 1001 for creation of a message to another buyer 1002, such as a friend or colleague with whom buyer 1001 wishes to attend the event. It is to be understood that the described method may apply to invitation of more than one additional party. However, for clarity, a sequence involving a single additional party is described herein.

At 1030, buyer 1001 provides information regarding the proposed second buyer, such as a full or partial name, address, or other identifying information to mobile app 1003 for use in a message to the proposed second buyer. At 1032, mobile app 1032 optionally performs a lookup of an address or identifier for the proposed second buyer 1002 at a message server 1006. Message server 1006 may be an email server, social networking platform, messaging server, or other communications server. In a preferred embodiment, information regarding the social network of buyer 1001 is used to predict and present potential invitees. Buyer 1001 may have previously registered his or her social networking accounts with either the ticketing server or the messaging server to provide access to address books or social network data.

At 1034, a prewritten message regarding the event and invitation is provided by message server 1006 to mobile app 1003 and presented to buyer 1001 for editing. At 1040, buyer 1001 edits the message, if desired, and provides an indication to the mobile app 1003 that it is complete. In one embodiment, the message is an email containing links to information regarding the event and purchase of tickets.

At 1042, mobile app 1003 presents a checkout form to buyer 1001. At 1050, buyer 1001 enters payment information. At 1052, mobile app initiates payment authorization either directly with payment processor 1008 or via ticketing server 1005. At 1054, payment processor 1008 confirms authorization to ticketing server 1005.

With the first payment from buyer 1001 authorized, but not yet settled, ticketing server sends a confirmation to buyer 1001 at 1056 and an invitation to buyer 2 at 1060. The invitation to buyer 1002 may be sent as an email via an intermediate server, as an alert or notification associated with mobile app 1004, or through other means. Preferably, the invitation provides a link or other user interface element providing one-click access to buyer 1002 to mobile app 1004 and further information regarding the invitation. Buyer 1001 may be provided with means, via mobile application 1003, to check the status of the invitation. It is again to be understood that while the application may refer to an embodiment using a mobile app, other implementations, such as the use of web or desktop applications are within the scope of the invention.

At 1070, buyer 1002 initiates purchase of a ticket via mobile app 1004. At 1072, mobile app requests details regarding the event or ticket from ticketing server 1005. At 1074, ticketing server 1005 provides information regarding the event or ticket to mobile app 1004, which is then presented to buyer 1002 in a checkout form at 1080. The ticketing server may preferably perform a check to confirm that sufficient and appropriate tickets are available for all members of the invitation group before allowing buyer 1002 to execute the purchase.

At 1082, buyer 1002 provides payment information to mobile app 1004. At 1084, mobile app 1004, directly or via ticketing server 1005, requests both authorization and settlement of the payment by buyer 1002.

Upon authorization of the payment of buyer 1002, the contingency of the ticket purchase of buyer 1001 is met and the system may settle both payments at 1086. At 1088, an indication of settlement of both payments is provided to ticketing server 1005. At 1090, confirmation of ticket purchase is sent to mobile app 1004 and presented by mobile app 1004 to buyer 1002 at 1092. At 1094, confirmation of ticket purchase is sent to mobile app 1002 and presented by mobile app 1002 to buyer 1002 at 1096.

If buyer 1001 invited more than one additional buyer 1002, the payment for each additional buyer may be authorized, but not settled, until the final buyer of the group commits to purchase. Thus, the actual charges, and in cases of reserved seating, ticket assignment, may be deferred until the all buyers have committed. Once all tickets are issued, each buyer may preferably be allowed to check-in using the self-portrait check-in procedure described above. In another embodiment, the initial buyer's purchase may be settled at the time of the first additional buyer's commitment (i.e., as soon as one additional attendee is confirmed). In some embodiments, the condition causing settlement of the first buyer's purchase may be configurable (e.g., after one invitee commits vs. after all invitees commit).

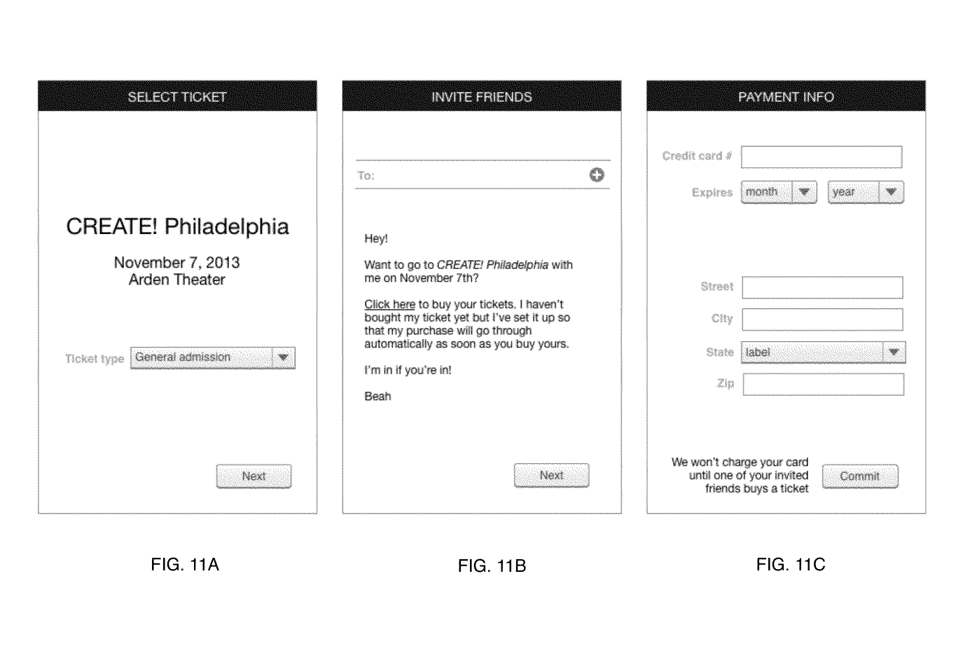

FIGS. 11A-11C are examples of user interface screens associated with an embodiment of a socially contingent ticket purchase system. It is again to be understood that while the example user interface screens are presented as mobile application screens, the system may also support interfaces provided through web browsers, desktop applications, or other means.

FIG. 11A is an example of a ticket selection screen for a particular event. The screen may preferably display a name, time, and location of the event, and provide a selection mechanism for a type of ticket. The user interface of FIG. 11A may, for instance, be displayed either after the user selected a search result from a list of returned events or in response to user selection of a link in an email or web page advertising the event. The user interface of FIG. 11A may be associated with interactions such as 1010 through 1022 above.

FIG. 11B is an example of an invitation user interface for a socially contingent ticket purchase. In a preferred embodiment, the invitation screen is displayed upon selection by the user of a submission button in a user interface of a ticket selection screen such as that of FIG. 11A. In other embodiments, the invitation screen may be displayed in response to explicit user selection of a user interface element associated with creating invitations. In a preferred embodiment, the invitation screen provides a pre-written email, which may be editable by the user, and accepts email addresses from the user. In other embodiments, one or more social media mechanisms may be used to convey the invitation. The user interface of FIG. 11B may be associated with interactions such as 1024 to 1040 above.

FIG. 11C is an example of a user interface screen for payment. Upon submission of the invitation message, the user may be presented with a payment user interface screen, such as the example shown in FIG. 11C. The interface may preferably accept payment information such as a credit card number, expiration date, and address. In some embodiments, the ticket purchase may utilize other payment systems for which the user has already provided credentials and/or funds. After submission of the payment form, payment may be authorized, though not settled, a confirmation screen may be provided, and the remained of the invitation process, such as described in FIG. 10, may be performed. The user interface of FIG. 11B may be associated with interactions such as 1042 to 1056 above.

As would be understood by one skilled in the art, the ticketing system may be implemented using a variety of hardware configurations. A single computer may provide all functions, or functions may be allocated amongst multiple machines, physical or virtual. For instance, data storage may be allocated to a specific machine or group of machines running database software. The system may utilize one or more separate web servers or load balancers. Each computer in the system may comprise a process for executed stored program code for performing the processes and methods described herein. Each computer may also comprise one or more network interfaces for communicating information as described. Each computer may also comprise one or more memories and storage devices for storing program code and data.

It should also be understood that while the system and associated methods have been described with respect to event ticketing, they might also be applied to other activities wherein identity needs to be verified by another party before allowing the holder to perform a task. For instance, the present system and methods may be applicable to tasks such as in-store pickup of an item purchased online. Instead of the name of an event, the self-portrait ticket may instead display a name or identifier of an item to be picked up. Other types of credentials, such as claim tickets, boarding passes, and the like may be sold, generated, and managed by the system.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present disclosure.

We claim:

1. A method of providing contingent purchase, comprising:
receiving a first request for a contingent first ticket purchase from a first purchaser;
receiving information regarding a second purchaser, wherein said contingent first ticket purchase is to be contingent upon a second ticket purchase by said second purchaser;
providing a notification to said second purchaser;
receiving an indication of an intent to purchase from said second purchaser; and
executing said first ticket purchase and said second ticket purchase.

2. The method of claim 1 wherein executing said first ticket purchase and said second ticket purchase comprises settling a first credit card purchase from said first purchaser and a second credit card purchase from said second purchaser.

3. The method of claim 1 wherein said notification to said second purchaser is one of an email, a social network message, an instant message, an SMS message, or an MMS message.

4. The method of claim 1 wherein said notification to said second purchaser is a notification presented on a mobile device.

5. The method of claim 1 wherein said indication of an intent to purchase from said second purchaser comprises execution of a check-out process.

6. The method of claim 1 further comprising receiving an indication of an intent to purchase from a third purchaser prior to receiving said indication of an intent to purchase from said second purchaser.

7. The method of claim 1 wherein said notification provides an indication of the event associated with said contingent first ticket purchase.

8. The method of claim 1 wherein said notification to said second purchaser comprises a selectable user interface element for directing said second purchaser to a checkout interface for their ticket.

9. The method of claim 1, further comprising:
prompting said first purchaser for login credentials;
receiving input of login credentials; and
providing said login credentials to a ticketing server for authentication.

10. The method of claim 1 wherein said ticket represents one of: an event ticket, a claim check, a boarding pass, a voucher, or a coupon.

11. A system for providing contingent purchase, comprising:
a memory for storing program code and data;
a network interface for receiving and transmitting data;
a processor configured to execute program code to facilitate performing the steps of:
receiving a first request for a contingent first ticket purchase from a first purchaser;
receiving information regarding a second purchaser, wherein said contingent first ticket purchase is to be contingent upon a second ticket purchase by said second purchaser;
providing a notification to said second purchaser;
receiving an indication of an intent to purchase from said second purchaser; and
executing said first ticket purchase and said second ticket purchase.

12. The system of claim 11 wherein executing said first ticket purchase and said second ticket purchase comprises settling a first credit card purchase from said first purchaser and a second credit card purchase from said second purchaser.

13. The system of claim 11 wherein said notification to said second purchaser is one of an email, a social network message, an instant message, an SMS message, or an MMS message.

14. The system of claim 11 wherein said notification to said second purchaser is a notification presented on a mobile device.

15. The system of claim 11 wherein said indication of an intent to purchase from said second purchaser comprises execution of a check-out process.

16. The system of claim 11 further comprising receiving an indication of an intent to purchase from a third purchaser prior to receiving said indication of an intent to purchase from said second purchaser

17. The system of claim 11 wherein said notification provides an indication of the event associated with said contingent first ticket purchase.

18. The system of claim 11 wherein said notification to said second purchaser comprises a selectable user interface element for directing said second purchaser to a checkout interface for their ticket.

19. The system of claim 11, further comprising:
prompting said first purchaser for login credentials;
receiving input of login credentials; and
providing said login credentials to a ticketing server for authentication.

20. The system of claim 11 wherein said ticket represents one of: an event ticket, a claim check, a boarding pass, a voucher, or a coupon.
